(19) United States
(12) Patent Application Publication
(10) Pub. No.: US 2022/0180071 A1
(43) Pub. Date: Jun. 9, 2022

(54) SYSTEM AND METHOD FOR ADAPTIVE MASKING AND NON-DIRECTIONAL LANGUAGE UNDERSTANDING AND GENERATION

(71) Applicant: Electronics and Telecommunications Research Institute, Daejeon (KR)

(72) Inventors: Eui Sok CHUNG, Daejeon (KR); Hyun Woo KIM, Daejeon (KR); Gyeong Moon PARK, Daejeon (KR); Jeon Gue PARK, Daejeon (KR); Hwa Jeon SONG, Daejeon (KR); Byung Hyun YOO, Daejeon (KR); Ran HAN, Daejeon (KR)

(73) Assignee: Electronics and Telecommunications Research Institute, Daejeon (KR)

(21) Appl. No.: 17/540,768

(22) Filed: Dec. 2, 2021

(30) Foreign Application Priority Data
Dec. 4, 2020 (KR) 10-2020-0168645

(51) Int. Cl. G06F 40/40; G06F 40/284; G06F 40/216

(52) U.S. Cl. CPC G06F 40/40; G06F 40/216; G06F 40/284

(57) ABSTRACT

Provided are a system and method for adaptive masking and non-directional language understanding and generation. The system for adaptive masking and non-directional language understanding and generation according to the present invention includes an encoder unit including an adaptive masking block for performing masking on training data, a language generator for restoring masked words, and an encoder for detecting whether or not the restored sentence construction words are original, and a decoder unit including a generation word position detector for detecting a position of a word to be generated next, a language generator for determining a word suitable for the corresponding position, and a non-directional training data generator for decoder training.

### CROSS-REFERENCE TO RELATED APPLICATION

This application claims priority to and the benefit of Korean Patent Application No. 10-2020-0168645, filed on Dec. 4, 2020, the disclosure of which is incorporated herein by reference in its entirety.

### BACKGROUND

### 1. Field of the Invention

The present invention relates to a system and method for adaptive masking and non-directional language understanding and generation.

### 2. Discussion of Related Art

Neural network language generation according to the related art has problems related to decoder-dependent training of an encoder-decoder model, non-dependence of words generated in future, and the like

### SUMMARY OF THE INVENTION

The present invention is directed to a system and method for adaptive masking and non-directional language understanding and generation that proposes a new training method of training an encoder-decoder model to train an encoder independently, avoid additional procedures in an end-to-end manner, and generate a non-directional language that is not unidirectional or bidirectional at the time of language generation.

The present invention relates to a system and method for adaptive masking and non-directional language understanding and generation.

The system for adaptive masking and non-directional language understanding and generation according to the present invention includes an encoder unit including an adaptive masking block for performing masking on training data, a language generator for restoring masked words, and an encoder for detecting whether or not the restored sentence construction words are original, and a decoder unit including a generation word position detector for detecting a position of a word to be generated next, a language generator for determining a word suitable for the corresponding position, and a non-directional training data generator for decoder training.

The adaptive masking block may perform masking by converting a predetermined ratio of words into a special symbol.

The language generator may restore the masked words to obtain a converted input string.

The encoder may compare an input string with a converted input string to perform change token prediction.

The decoder unit may generate a word by inputting a context, determine a next word generation position by inputting the context and a pre-generated word, generate a next word by inputting the context and pre-generated word to the determined word generation position, and stop a non-directional language generation procedure when the generated word is a sentence termination symbol.

The generation word position detector may derive the position of the word to be generated next by inputting a current context and a generated partial result using non-directional training data having a corresponding language generation order.

The non-directional training data generator may derive a language generation order that is highly relevant to input context.

The decoder unit may perform parallel decoding at a time of language generation.

When performing the masking, the encoder may adjust a masking ratio by reflecting characteristics of a language generator in which training is in progress.

As performance of the language generator is improved, noise of an input sentence may be maintained at a predetermined ratio or more by increasing a masking probability value for a construction vocabulary.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 illustrates structures of an encoder and a decoder constituting a system for adaptive masking and non-directional language understanding and generation according to an embodiment of the present invention;

FIG. 2 illustrates an example of a non-directional language generation order according to an embodiment of the present invention;

FIG. 3 illustrates a non-directional language generation procedure according to an embodiment of the present invention;

FIG. 4 illustrates an example of generating training data for non-directional language generation according to an embodiment of the present invention;

FIG. 5 illustrates a procedure of generating training data for non-directional language generation according to an embodiment of the present invention; and

FIG. 6 illustrates an example of relative positional encoding and decoding according to an embodiment of the present invention.

### DETAILED DESCRIPTION OF EXEMPLARY EMBODIMENTS

The above-described aspect, and other aspects, advantages, and features of the present invention and methods accomplishing them will become apparent from the following detailed description of exemplary embodiments with reference to the accompanying drawings.

However, the present invention may be modified in many different forms and it should not be limited to the exemplary embodiments set forth herein. Only the following embodiments are provided to easily inform those of ordinary skill in the art to which the present invention pertains that the object, configuration and effect of the invention, and the scope of the present invention is defined by the description of the claim.

Meanwhile, terms used in the present specification are for explaining exemplary embodiments rather than limiting the present invention. Unless otherwise stated, a singular form includes a plural form in the present specification. Components, steps, operations, and/or elements described by the terms “comprise” and/or “comprising” used in the present invention do not exclude the existence or addition of one or more other components, steps, operations, and/or elements.

Hereinafter, in order to facilitate the understanding of those skilled in the art, a background in which the present invention is proposed will be first described, and embodiments of the present invention will be described.

According to the related art (Song, Kaitao, et al. “Masked Sequence to Sequence Pre-training for Language Generation (MASS)” ICML. 2019.), MASS provides a pre-training method that provides a seq-to-seq training framework.

In an encoder, several consecutive tokens that are part of a sentence are masked fragments, and a decoder performs training with an approach of predicting the masked fragments based on results of the encoder.

In the training process, a masked language model technique may be performed to generate left and right contexts as a condition.

According to the related art, as in the existing approach, there is a limitation in showing an approach limited to unidirectional generation in a test operation, not a training operation, and the training of the encoder is dependent on masking symbol prediction of the decoder.

According to the related art (Dong, Li, et al. “Unified Language Model Pre-training for Natural Language Understanding and Generation.” Advances in Neural Information Processing Systems. 2019.), UniLM is a fine-tune model that can be applied to both language understanding and language generation.

A pre-training method using unidirectional, bidirectional, and seq-to-seq predictions is proposed.

The unified model includes a shared transformer network and special self-attention masks.

An approach that may directly utilize bidirectional encoder representations from transformers (BER), a pre-training model, for language generation has been proposed, but there is a problem that language generation in the training operation and test operation is unidirectional.

Further, the training of the encoder uses a masked language model (LM) as in the BERT model.

Since only masked words are trained, a long training time is required to train the encoder.

According to the related art (Clark, Kevin, et al “Pre-training Text Encoders as Discriminators Rather Than Generators (ELECTRA).” ICLR 2020), an ELECTRA model trains an encoder by an approach of predicting words in a masked input string using a small-scale language generation model and determining whether words in an input string have changed through a network acting as a discriminator.

Finally, only the discriminator is used.

Herein, an approach of maintaining an appropriate amount of noise through a small-scale language generation model has been attempted.

According to the related art (Zhou, Long, Jiajun Zhang, and Chengqing Zong. “Synchronous Bidirectional Neural Machine Translation.” Transactions of the Association for Computational Linguistics 7. 2019.), great achievements were made by proposing a bidirectional language generation technique in neural network machine translation.

By simultaneously performing left-to-right (L2R) and right-to-left (R2L) decoding to enable mutual attention, the results of future vocabulary generation were used at the time of language generation.

However, the related art has a problem in that words generated in future are suggested at the time of training and only the neural network machine translation is verified.

Presenting the words generated in future at the time of training means a role of indirectly pre-presenting the correct answer result.

Therefore, according to the related art, an approach of reinforcing training data in a direction opposite to a generation direction of results by separately training independent L2R and R2L decoders was proposed.

Unlike machine translation which is a field of directed language generation, the verification only for the machine translation has a problem in that the possibility of use for open-end language generation such as story generation or dialogue is not confirmed.

According to the related art (Gu, Jiatao, Qi Liu, and Kyunghyun Cho. “Insertion-based Decoding with Automatically Inferred Generation Order.” Transactions of the Association for Computational Linguistics 7 (2019): 661-676.), a language generation approach of finding words to be generated next by inputting a partially generated sentence and then finding an insertion position of the corresponding words was proposed.

For the language generation order, both a position prediction module and a word prediction module were used, and beam search considering noise was used.

An approach for rearranging position encoding and sentence order using ternary relative positional encoding having three values is proposed.

According to the related art, there is a problem that it is possible to generate only one word at a time.

The present invention has been proposed to solve the above problems, and the present invention proposes a new training method for training an encoder-decoder model. In the case of an encoder, the new training method is designed to deviate from decoder-dependent training of the existing encoder-decoder model, train the encoder independently, and avoid additional procedures in an end-to-end manner. In addition, the present invention proposes a non-directional language generation technology that is not unidirectional or bidirectional at the time of language generation. Here, when training and testing a neural network language generation model, there is a technical challenge in determining a language generation order. The next technical challenge is how to perform language generation at a determined language generation position.

The present invention proposes an approach that can directly train an encoder and design the encoder to reflect the results of the encoder for all vocabulary in training. A decoder model of the entire seq-to-seq is used, and a masked language model (MLM) of a decoder, which has gradually improved performance, is controlled using adaptive masking.

The present invention can simultaneously utilize left/right context through language generation using MLM and continuously detect a position of an additionally generated word in a partial generation result, and thus can be used in open-end language generation technology.

According to the present invention, it is possible to find a position first, estimate a word using left/right context at the corresponding position, use a full length in applying relative positional encoding, estimate a plurality of insertion positions, and perform a parallel generation approach of generating words at the plurality of corresponding positions, respectively.

According to an embodiment of the present invention, a language understanding and generation technology with adaptive masking and non-directional features is presented.

The entire proposed model is configured in a seq-to-seq form of an encoder-decoder structure.

The encoder is trained using the MLM.

The MLM converts some input strings into mask symbols and predicts correct words of the corresponding symbols.

The encoder is trained through a procedure of determining whether the input string changed by the MLM matches an original input string.

The MLM is trained like the encoder, and there is a problem that, when the performance gradually increases, the noise of the changed input string gradually decreases, and according to an embodiment of the present invention, a predetermined ratio of noise is maintained through the adaptive masking.

The decoder uses a neural network-based non-directional language generation technology.

There is a problem in that the existing language generation has a unidirectional feature, and when generating a sentence, is dependent only on a pre-generated partial sentence at the time of generating a construction word. In addition, the existing language generation has a problem that a word to be generated next may not be used for generating a current word.

According to the embodiment of the present invention, it is possible to maximize the amount of information required for language generation by presenting a non-directional language generation technology that is not unidirectional or bidirectional at the time of the language generation.

The encoder for language understanding includes an adaptive masking block that performs masking on encoder training data, a language generator that restores masked words, and an encoder that detects whether the restored sentence construction words are original.

The decoder for language generation includes a generation word position detector that detects a position of a word to be generated next in the partially generated string, a language generator that determines a word suitable for the corresponding position, and a non-directional training data generator for decoder training.

According to the embodiment of the present invention, it is possible to use a system and method for adaptive masking and non-directional language understanding and generation in a pre-training approach of an encoder-decoder structure and in a field of language generation such as machine translation, dialog processing, and document summary.

The present invention aims to improve training and performance of a neural network of an encoder-decoder structure, and the present invention attempts to enable an end-to-end type training by removing essential procedures required in advance for training the neural network.

For this purpose, the encoder training is performed using the language generator which is a component of the entire neural network.

Then, an adaptive masking approach is presented to attempt to strengthen the usability of the language generator during training.

In addition, according to the embodiment of the present invention, a neural network-based non-directional language generation technology is presented.

To date, the language generation technology has attempted a unidirectional or bidirectional approach.

In the case of the bidirectionality, the L2R and R2L generation are performed simultaneously, and as a result, it can be seen that the problem of unidirectionality is inherited to some extent.

When the language generation has the non-directional feature, there is an advantage that both the left and right contexts may be used at the time of the language generation.

According to the embodiment of the present invention, the following three assumptions are made for the non-directional approach for the language generation.

First, when generating the sentence, content and grammar are structurally separated.

Second, content, that is, words, are generated in the order of greatest relevance according to context.

Third, content, that is, grammar, constructing words function to determine the order of words.

According to the embodiment of the present invention, based on these three assumptions, a neural network-based non-directional language generation system and method are provided.

According to the embodiment of the present invention, the encoder-decoder model can use a pre-training model such as BERT and generative pre-trained transformer (GPT).

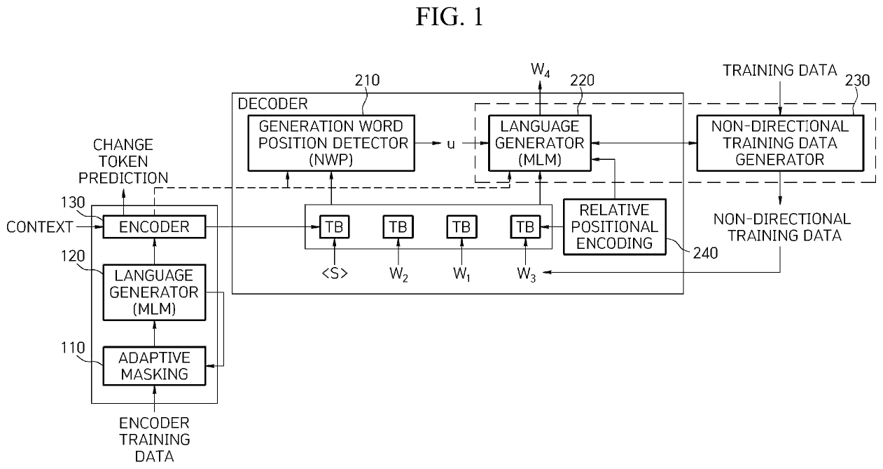

FIG. 1 illustrates structures of an encoder and a decoder constituting a system for adaptive masking and non-directional language understanding and generation according to an embodiment of the present invention.

Encoder-decoder training according to the related art is performed using language generation accuracy of the decoder using a sentence input to the encoder and a sentence input to the decoder.

According to the embodiment of the present invention, the encoder can be trained independently using the sentence input to the encoder.

The encoder training data includes an input string x in which words are connected.

An adaptive masking block 110 performs masking by converting a predetermined ratio of words into special symbols.

The language generator 120 attempts to restore the corresponding masked words to obtain a converted input string x′.

The encoder 130 performs encoder training through a procedure of performing change token prediction by comparing x′ with the input string x.

Referring to FIG. 1, in order to generate a non-directional language, the decoder includes a generation word position detector 210 (next work position detector (NWP)) that detects a position of a word to be generated next in a partially generated string, a language generator 220 (MLM) to determine a word suitable for the corresponding position, and a non-directional training data generator 230 for decoder training.

The generation word position detector 210 derives a next language generation position by inputting current context and a generation partial result using the non-directional training data having the corresponding language generation order.

The language generator 220 processes two tasks that perform a non-directional training data generation function and a next word generation function.

A transformer block (TB) that processes an input word of the decoder denotes a Tensorflow block and becomes a substructure of the generation word position detector 210 and the language generator 220.

The relative positional encoding 240 denotes relative positional encoding and provides additional context information in word generation of the language generator 220 according to the result of the generation word position detector 210.

The non-directional training data generator 230 derives a language generation order that is highly relevant to the input context.

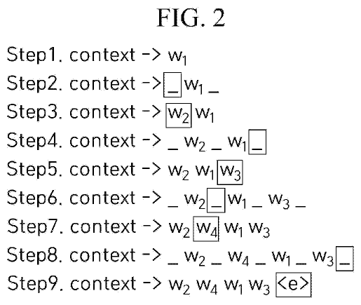

FIG. 2 illustrates an example of a non-directional language generation order according to an embodiment of the present invention.

In Step 1, context is converted into a state vector value in the encoder, and the decoder generates a first word w₁.

In Step 2, the next word generation position is determined by inputting context and the currently generated w₁.

In Step 3, a word w₂ is generated at the determined word generation position.

By being repeated from Step 2, the language generation proceeds until a final sentence termination symbol <e> is found.

Steps 1, 3, 5, 7, and 9 are performed by the language generator 220 (MLM), and steps 2, 4, 6, and 8 are performed by the generation word position detector 210 (NWP) of FIG. 1.

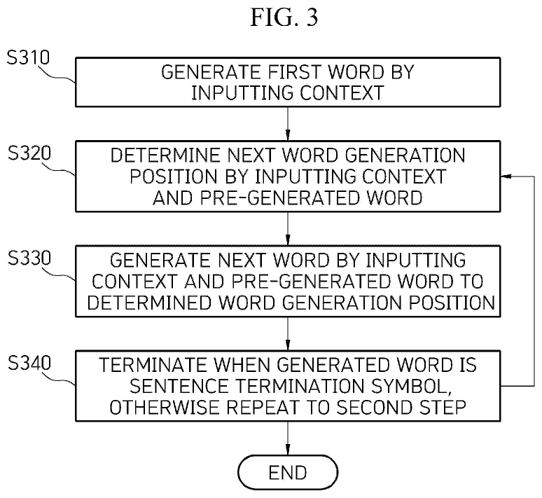

FIG. 3 illustrates a non-directional language generation procedure according to the embodiment of the present invention.

In step S310, the first word is generated by inputting the context.

In step S320, a next word generation position is determined by inputting the context and the pre-generated word.

In step S330, the next word is generated by inputting the context and the pre-generated word to the determined word generation position.

In step S340, when the generated word is a sentence termination symbol, the procedure ends, otherwise it returns to step S320.

In order to train the language generator 220 so that the non-directional language generation procedure illustrated in FIG. 2 is enabled, the training data should be modified to be suitable for non-directionality.

w₂, w₄, w₁, and w₃ presented in step 9 of FIG. 2 are a language generation result of the decoder.

The generation order proceeds in the order of w₁, w₂, w₃, and w₄.

Since the training data cannot know the corresponding order in advance, it is necessary to find out the corresponding generation order.

This is processed in the non-directional training data generator 230 and, as illustrated in FIG. 1, generates the non-directional training data by inputting the training data.

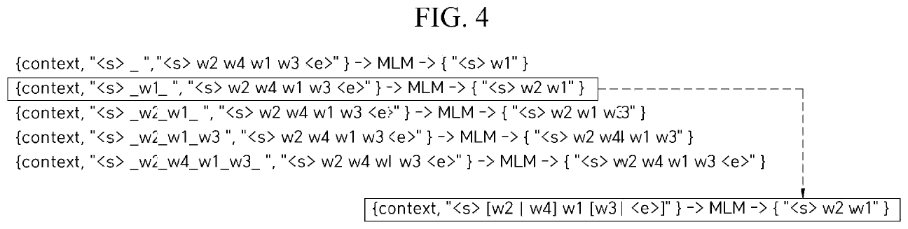

FIG. 4 illustrates an example of generating training data for non-directional language generation according to an embodiment of the present invention.

The language generator 220 receives context and a start symbol <s> of a sentence, and training data as input.

The final generation results according to the embodiment of the present invention are described in advance in the training data and expressed as “<s>w₂ w₄ w₁ w₃<e>.”

Since the language generator 220 may know a word candidate, which may come to the right of <s>, in advance from the training data, the language generator 220 determines the word w1 having the greatest generation probability among the corresponding words.

This becomes a third word in the actual word.

Therefore, a second intermediate result is “<s>_w₁_,” and a position of a next comparison target word is w₂ on the left of w₁, and the word w3, <e> on the right of w₄ and w₁.

Here, when it is determined that w₂ has the greatest generation probability, the language generator 220 generates the corresponding word.

The language generator 220 may be applied at a time point when the training does not end.

Therefore, an e-greedy approach may be taken.

That is, a word is randomly selected with a specific probability e, and the language generator is applied with a probability of 1-e.

When the order of all words in one sentence of the training data is determined by repeating this process, the non-directional training data generation procedure is completed.

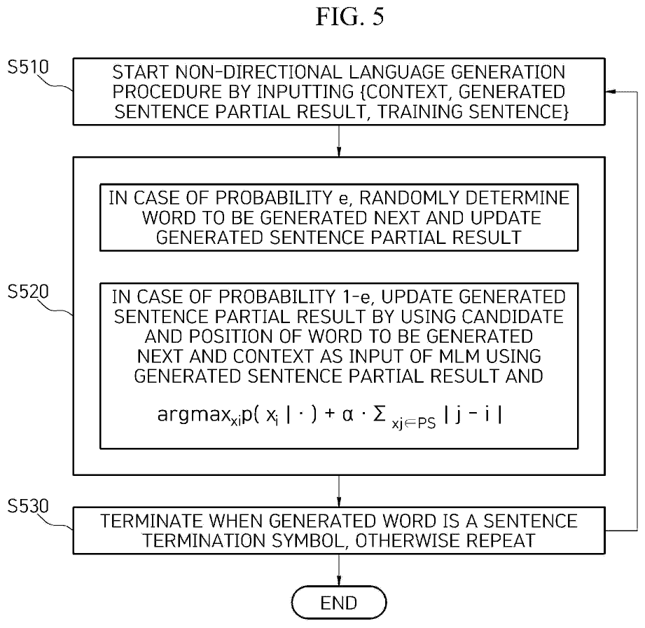

FIG. 5 illustrates a procedure of generating training data for non-directional language generation according to an embodiment of the present invention.

The non-directional language generation procedure is started by inputting the context, the generated sentence partial result, and the training sentence (S510).

The language generator 220 determines the order of generated words in the sentence.

In the case of the probability e, the next generated word is randomly determined, and the generated sentence partial result is updated. In the case of the probability l-e, the generated sentence partial result is updated by inputting the position and context of the next generated word and the context to the language generator 220 by using the generated sentence partial result and the training sentence (S520).

In general, unlike sentences generated by humans, the language generator 220 is a type of language model, so there is a high probability that high-frequency words have a high probability of being present.

This may cause a problem in estimating the generation order of the non-directional training data.

According to the embodiment of the present invention, words are prevented from being generated at consecutive positions in a sentence as in [Equation 1].

That is, xᵢ is selected so as to maximize a distance from word xⱼ constituting a partial generation sentence PS as much as possible.

argmaxₓ_{ᵢ}p(xᵢ|⋅)+α·Σₓ_{ⱼ}_{∈PS}|j−i| [Equation 1]

Step S530 terminates the procedure when a generated word is a sentence termination symbol, and returns to step S510 when the generated word is not a sentence termination symbol.

Hereinafter, the training of the decoder according to the embodiment of the present invention will be described.

Both the generation word position detector 210 and the language generator 220 share a transformer block (TB) as a substructure and are implemented as a neural network structure of various structures.

The inputs and outputs of the encoder and the decoder illustrated in FIG. 1 take Steps 6 and 7 illustrated in FIG. 2 as examples.

Encoding is performed by inputting the context into the encoder, and “<s> w₂ w₁ w₃,” which is the result of the generated sentence part, is input to the decoder.

After generating the result of the corresponding sequence using the transformer block (TB), a position u of a word to be generated next is generated using the generation word position detector 210.

A line connected from the encoder 130 to the generation word position detector 210 by a dotted line in FIG. 1 denotes attention.

That is, a next position candidate of “<s> w₂ w₁ w₃” is “<s> _0 w₂ _1 w₁ _2 w₃ _3” and there are three “_0, _1, _2,” and the generation word position detector 210 obtains the respective probabilities and performs the training to maximize the correct position u.

That is, the generation word position detector 210 obtains a probability distribution p=(p₀ . . . p|S|) for a next language generation position i when S=w₂ w₁ w₃ and performs training so that the probability pᵤ of the correct position u is maximized. A loss function is described as in [Equation 2] below.

[Equation 2]

L_{nwp}(p,u)=−log pᵤ (Equation 2)

When the correct answer position u is determined, a word suitable for the corresponding position is generated, and the language generator 220 performs the generation.

As the input, the context and the generated sentence partial result are generated through the TB, and the word generation probability suitable for the corresponding position is obtained using u of the generation word position detector 210.

Similar to the generation word position detector 210, the output information of the encoder is connected through the attention.

When a set of vocabulary is V, the probabilities for all vocabulary are calculated.

When this is described as q^{u}=(q₀ . . . q|V|−1), the loss function that may train the language generator is as in [Equation 3] below.

Lₘₗₘ(p^{u},w)=−log q_{w} [Equation 3]

The training of the decoder is simultaneously performed in the generation word position detector 210 and the language generator 220.

Using constant λ, a multi-tasked loss function may be described as shown in [Equation 4] below, and the training proceeds in a direction of minimizing the next loss function.

L(p,u,q^{u}w)=L_{nwp}(p,u)+λLₘₗₘ(p^{u},w) [Equation 4]

Hereinafter, the decoder training in consideration of the de-generation problem according to the embodiment of the present invention will be described.

As a chronic problem of the language generation, there is the issue of the de-generation.

The de-generation refers to a phenomenon of repetitive vocabulary generation.

This is because the language training is dependent on a maximum likelihood estimation (MLE) approach.

That is, words similar to the partially generated vocabulary are selected and generated.

According to the related art, in order to cope with this problem, a Top-k, Top-p approach that randomly selects one of various candidates at the time of decoding has been presented (Holtzman et al.).

Also, according to the related art, an unlikelihood estimation technology that excludes words that have already been generated in the training operation has been proposed (Welleck et al.).

According to the embodiment of the present invention, a training method is proposed in which an embedding value of vocabulary constructing the partial generation sequence and a penalty for close distance vocabulary are reflected at the time of the training.

[Equation 5] below is a loss function that reduces a probability value of vocabulary xᵢ similar to an embedding value of xⱼ constituting partial generation sequence x_{masked} already generated by the language generator.

$${ℒ}^{i} ( {p}_{θ} ( \cdot \vert {x}_{masked} ) , e ( \cdot ) ) = - log {p}_{θ} ( {x}_{i} \vert {x}_{masked} ) - α \cdot {\sum }_{{x}_{i} ∈ {x}_{masked}} d ( e ( i ) , e ( j ) ) \qquad [ Equation 5 ]$$

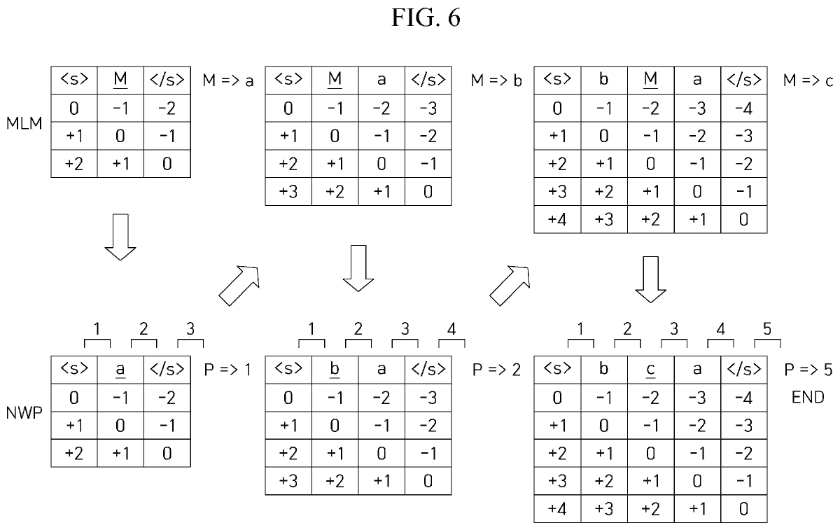

FIG. 6 illustrates an example of relative position encoding and decoding according to an embodiment of the present invention.

FIG. 6 illustrates an example of interaction and relative position encoding of the language generator and the generation word position detector.

First, in <s>M</s>, M becomes a mask symbol, and the language generator predicts the vocabulary substituted for the corresponding M.

Here, M becomes a.

In the corresponding matrix, the following numbers are the relative positional encoding and represent each left and right distance value.

In the case of M, three relative position encoding values of −1, 0, and +1 are used, which are expressed as a column.

Thereafter, the generation word position detector detects a next insertion position.

Position value candidates are used by combining hidden values of adjacent words.

It is possible to confirm three position candidates 1, 2, and 3.

Here, as an optimal position, P has a value of 1, and the procedure is repeated again and ends when the final position is confirmed.

The generation word position detector can predict one or more position values, and the language generator can predict vocabulary for a plurality of position values.

Referring to FIG. 6, by performing parallel decoding at the time of the language generation, it is possible to improve an execution speed more than sequentially predicting single words.

According to the embodiment of the present invention, the encoder-decoder structure may perform training at the same time, or the encoder part may be trained separately.

When the input sentence x is converted into x′ by the language generator, an approach is taken of reducing the likelihood of words that are different from the original and maximizing the likelihood of words with the same result as the original.

Here, a discriminator becomes the encoder, and the corresponding loss equation is as in [Equation 6] below.

[symbol]

_{E}(x,θ_{E})= [symbol] (Σₜ₋₁ⁿ−1(x′ₜ=xₜ)log E(x′ₜ,xₜ)−1(x′ₜ≠xₜ)log(1−E(x′,t))) [Equation 6]

According to the embodiment of the present invention, when the masking is performed, the masking ratio is adjusted by reflecting the characteristics of the language generator in which the learning is in progress.

When the input sentence is x=(x₁, x₂, . . . , x_{T}), in the case where the masking is denoted by m=(m₁, m₂, . . . , m_{T}), mᵢ=1 means that xᵢ is converted into a mask symbol, and mᵢ=0 means that the vocabulary is maintained without change.

Here, when the masking probability for the construction vocabulary of x is denoted by r, it can be described as a Bernoulli probability distribution as in [Equation 7] below.

Bern(m;r)=r^{m}·(1−r)^{1-m} [Equation 7]

According to the embodiment of the present invention, as the performance (ACC_of_MLM) of the language generator is improved as shown in [Equation 8], the noise of the input sentence is maintained at a certain rate by increasing the corresponding r value.

It is possible to apply the changed r value after a certain timestep or to update the r value in epoch units.

[Equation 8]

r←r [symbol] α·ACC_of_MLM (Equation 7)

Meanwhile, the method of adaptive masking and non-directional language understanding and generation according to an embodiment of the present invention may be implemented in a computer system or recorded on a recording medium. The computer system may include at least one processor, a memory, a user input device, a data communication bus, a user output device, and storage. Each of the above-described components performs data communication through the data communication bus.

The computer system may further include a network interface coupled to a network. The processor may be a central processing unit (CPU) or a semiconductor device that processes instructions stored in the memory and/or storage.

The memory and storage may include various types of volatile or non-volatile storage media. For example, the memory may include a read only memory (ROM) and a random access memory (RAM).

Therefore, the method of adaptive masking and non-directional language understanding and generation according to the embodiment of the present invention may be implemented in a computer-executable method. When the method of adaptive masking and non-directional language understanding and generation according to the embodiment of the present invention is performed in a computer device, computer-readable instructions may perform the method of adaptive masking and non-directional language understanding and generation according to the present invention.

Meanwhile, the method of adaptive masking and non-directional language understanding and generation according to the present invention described above may be implemented as computer-readable code on a computer-readable recording medium. The computer-readable recording medium includes any type of recording medium in which data readable by a computer system is stored. For example, there may be a ROM, a RAM, a magnetic tape, a magnetic disk, a flash memory, an optical data storage device, and the like. In addition, the computer-readable recording medium may be distributed in computer systems connected through a computer communication network, and stored and executed as readable codes in a distributed manner.

According to the present invention, it is possible to use a system and method for adaptive masking and non-directional language understanding and generation in a pre-training approach of an encoder-decoder structure, and in a field of language generation such as machine translation, dialog processing, and document summary.

According to the present invention, it is possible to solve the problem related to dependence on fragmentary information of the language generation technology according to the related art and to apply a result of a pre-generated language model to a language generation technology without change.

By separating a sentence generation process into content and grammar, it is possible to solve the problem of non-dependence of words generated in future, which is a limitation of the neural network language generation technology according to the related art.

By proposing an approach that can preferentially perform the generation of context-related important words when generating sentences, it is possible to make language generation more similar to a human cognitive process and solve a de-generation problem of language generation through an unlikelihood technology based on non-proximity language generation order estimation and a word embedding value.

By proposing an independent training method for an encoder itself in an encoder-decoder structure through an adaptive masking technology, it is possible to improve a pre-training method according to the related art.

By performing parallel decoding at the time of language generation, it is possible to improve the execution speed more than sequentially predicting single words.

The effects of the present invention are not limited to those described above, and other effects not described can be clearly understood by those skilled in the art from the above detailed description.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A system for adaptive masking and non-directional language understanding and generation, the system comprising:
an encoder unit including an adaptive masking block for performing masking on training data, a language generator for restoring masked words, and an encoder for detecting whether or not the restored sentence construction words are original; and
a decoder unit including a generation word position detector for detecting a position of a word to be generated next, a language generator for determining a word suitable for the corresponding position, and a non-directional training data generator for decoder training.

2. The system of claim 1, wherein the adaptive masking block performs masking by converting a predetermined ratio of words into a special symbol.

3. The system of claim 1, wherein the language generator restores the masked words to obtain a converted input string.

4. The system of claim 3, wherein the encoder compares an input string with a converted input string to perform change token prediction.

5. The system of claim 1, wherein the decoder unit generates a word by inputting a context, determines a next word generation position by inputting the context and a pre-generated word, generates a next word by inputting the context and pre-generated word to the determined word generation position, and stops a non-directional language generation procedure when the generated word is a sentence termination symbol.

6. The system of claim 1, wherein the generation word position detector derives the position of the word to be generated next by inputting a current context and a generated partial result using non-directional training data having a corresponding language generation order.

7. The system of claim 1, wherein the non-directional training data generator derives a language generation order that is highly relevant to input context.

8. The system of claim 1, wherein the decoder unit performs parallel decoding at a time of language generation.

9. The system of claim 1, wherein, when masking is performed, the encoder adjusts a masking ratio by reflecting characteristics of a language generator in which training is in progress.

10. The system of claim 1, wherein, as performance of the language generator is improved, noise of an input sentence is maintained at a predetermined ratio or more by increasing a masking probability value for a construction vocabulary.
